(19) United States
(12) Patent Application Publication
(10) Pub. No.: US 2026/0331943 A1
(43) Pub. Date: Oct. 22, 2026

(54) SMART UNINTERRUPTIBLE POWER SUPPLY SYSTEM

(71) Applicant: CI CORPORATION PTY LTD, Queensland (AU)

(72) Inventor: Ahmed El Safty, Queensland (AU)

(21) Appl. No.: 19/486,171

(22) PCT Filed: May 21, 2024
(86) PCT No.: PCT/AU2024/050514

§ 371 Date: Nov. 20, 2025

(30) Foreign Application Priority Data
May 21, 2023 (AU) 2023901582

(51) Int. Cl. H02J 9/06; H02J 13/10; H02J 13/13; H02J 13/181; H02J 13/34; H02J 101/24; H02J 107/10

(52) U.S. Cl. CPC H02J 9/062; H02J 9/061; H02J 13/10; H02J 13/1321; H02J 13/181; H02J 13/34; H02J 2101/25; H02J 2107/10

(57) ABSTRACT

An uninterruptible power supply system enables versatile power source selection based on present loading. The system comprises: a primary power source selector that is selectable between a plurality of primary power source options; a battery management system comprising a plurality of battery management units; a controller for controlling the primary power source and the battery management system; and a bus subsystem including a controller area network bus for connecting together the primary power source selector, the battery management system and the controller. A primary power source selected by the primary power source selector is determined by the controller based on an analysis of primary power source parameters and peripheral load parameters.

### FIELD OF THE INVENTION

The present invention relates to a smart uninterruptible power supply (“Smart UPS”) system with some embodiments including optimal energy management, embedded machine learning, internet-of-things (“IoT”), remote control, and remote diagnosis.

### BACKGROUND OF THE INVENTION

As society becomes more aware of the impact of climate change, there is growing recognition of the need to shift towards more sustainable and better utilised energy sources. One area where this shift is particularly important is in the use of the Smart UPS, which are crucial for providing uninterruptible power in case of a grid failure.

While traditional Smart UPS systems have relied on fossil fuel-based electricity generation, there is a growing trend towards using renewable energy sources such as solar and wind power to supply these systems.

The current UPS systems lack the ability to self-optimise and improve as their algorithms and event management are pre-programmed. Therefore, there is a requirement for a Smart UPS system that can leverage the latest advancements in artificial intelligence (“AI”) to learn from existing data and autonomously adjust configurations to enhance the system's overall performance.

Conventional UPS systems face difficulties in implementing remote control and diagnosis capabilities. Consequently, there is a need for a Smart UPS system that leverages IoT technology, allowing users to access the system from anywhere and at any time.

It is a challenging task for conventional UPS systems to build and integrate the capacity to provide and display visualised user data on a remote portal. There is a need for a Smart UPS system to enable the end user to monitor the system status in real-time.

Conventional UPS systems operate on a basic “on” and “off” logic to supply power to loads, whereas modern smart loads can offer additional information beyond just power status. For instance, a smart refrigerator can communicate its current temperature, operational hours, and energy consumption through a communication channel. Therefore, there is a requirement for a Smart UPS system that can communicate with smart loads, collect, and analyse data.

### OBJECT OF THE INVENTION

It is an object of the present invention to overcome and/or alleviate one or more of the disadvantages of the prior art or provide the consumer with a useful or commercial choice.

### SUMMARY OF THE INVENTION

Some embodiments of the present invention ensure energy security and optimise the use of renewable energy sources from either grid-based supply or a renewable energy source.

Some embodiments of the present invention are designed to support the primary power source from the electricity grid and renewable energy facilities. The switching between the two is controlled by the system software based on the operational conditions, for example, the availability of the renewable energy source, the status of charge of the battery, and the grid stability. The algorithm implemented in the software is designed to maximise the benefit from the renewable energy source, and therefore, reduce the emissions.

Some embodiments of the present invention have embedded machine learning capability to support AI-based self-optimisation and the self-improvement. With the specifically designed AI algorithms, it can perform tasks such as predictive maintenance by analysing data available to predict when maintenance is needed and identify potential problems before they occur, and the real-time information is displayed on the remote portal, making it simple for users to monitor; smart fault detection by analysing data on voltage, current, and other parameters to identify patterns that might indicate a fault; smart load balancing by optimising the distribution of power across multiple nodes of Smart UPS systems; and promote the energy efficiency by optimizing the power consumption, distribution and scheduling based on the identified patterns and trends.

The portal is a software program specifically designed to display user data visualizations from the Smart UPS system on a remote computer. The Smart UPS system collects data and transports it to an IoT broker using message queueing telemetry transport (“MQTT”) protocol, where it is then stored in a database on a Cloud server. The Smart UPS utilises six uplink channels to upload data and four downlink channels to receive commands from the portal.

Users can access stored data and system information, system configurations, environmental information as well as current grid energy pricing via a mobile app.

Furthermore, the database is designed to accommodate multiple Smart UPS systems, providing separate storage space within the database.

Some embodiments of the present invention allow for remote control and diagnosis through designated pages on the portal. In the control page, users can select commands from a list and send them to the Smart UPS system for processing and execution. In the diagnosis page, users can access system information, warning messages, and troubleshooting hints.

Warning messages can also be sent via email and short message service (“SMS”).

Some embodiments of the present invention communicate with smart loads to gather information and dynamically update system configurations to achieve optimal efficiency. The system also includes the ability to connect and disconnect loads based on programmed logic, similar to conventional UPS systems.

Some embodiments of the present invention consist of eight essential components that work together to provide reliable and uninterruptible power supply to connected electrical utilities. These components include the controller for system operation, the battery as a backup power source, the alternating current/direct current (“AC/DC”) converter for battery charging, the DC/AC converter for using the backup power source, the communication hub to provide an external link, the smart switch array to control target objects, the portal as a user interface, and the local dashboard for testing and system configuration.

Some embodiments of the present invention can be configured as a plug-and-play standalone device by excluding features such as renewable energy sources and cloud services.

Some embodiments of the present invention enable rapid power up of commercial or residential appliances at a millionth-second level in response to brief interruptions or dips in voltage.

According to one aspect, although not necessarily the broadest aspect, the invention resides in an uninterruptible power supply system, comprising:
a primary power source selector that is selectable between a plurality of primary power source options;
a battery management system comprising a plurality of battery management units;
a controller for controlling the primary power source and the battery management system; and
a bus subsystem including a controller area network (“CAN”) bus for connecting together the primary power source selector, the battery management system and the controller;
   wherein a primary power source selected by the primary power source selector is determined by the controller based on an analysis of primary power source parameters and peripheral load parameters.

Preferably, the controller is connectable to a display panel dashboard for providing a local interface for system testing, debugging and configuration.

Preferably, the uninterruptible power supply system of claim 1, wherein the dashboard provides end users with visualised real-time data.

Preferably, the controller includes an array of smart switches designed and wired to perform control tasks over specific target objects.

Preferably, the controller enables peripherals and features to be excluded so that the system can be used as a plug-and-play standalone device using a wall socket as the primary power source.

Preferably, the plurality of primary power source options are selected from: grid power; engine generator power; solar power; wind power; hydro power; and external battery power.

### BRIEF DESCRIPTION OF THE DRAWINGS

FIG. 1 is a diagram that illustrates the architecture of a Smart UPS system according to some embodiments of the present invention.

FIG. 2 is a diagram that illustrates a detailed view for how to interface the controller with other devices including the batteries and the smart switches according to some embodiments of the present invention.

FIG. 3 is a diagram that illustrates a detailed view for how to interface the controller with the Internet, the Cloud server and the local dashboard according to some embodiments of the present invention.

FIG. 4 is a diagram that illustrates a detailed view for how to interface the controller with smart loads and the normal loads according to some embodiments of the present invention.

FIG. 5 is a diagram that represents a flow chart for the system software running on an embedded platform of the controller according to some embodiments of the present invention.

FIG. 6 illustrates the plug-and-play variation of a Smart UPS system according to some embodiments of the present invention.

### DETAILED DESCRIPTION OF EMBODIMENTS

The features depicted and described with reference to the drawings are not intended to limit the scope of the invention, as other features may also be included.

Some embodiments of the present invention provide a Smart UPS where the primary power source supplies power both to the appliance and the battery via a charger. The primary power source can be an electricity grid accessed via a wall socket or renewable energy such as solar panels. The added benefit of the Smart UPS ensures that in the event of a power outage or disruption, electrical systems remain running without interruptions. Furthermore, the Smart UPS is a plug-and-play device, via a wall socket, while electrical appliances can be connected to power outlets on the side of the unit. The Smart UPS includes advanced features which are standard such as embedded machine learning stack, IoT via MQTT, Cloud service, remote database access, remote control, and remote system diagnosis via the Internet. The Smart UPS can easily be reconfigured for advanced features such as solar power.

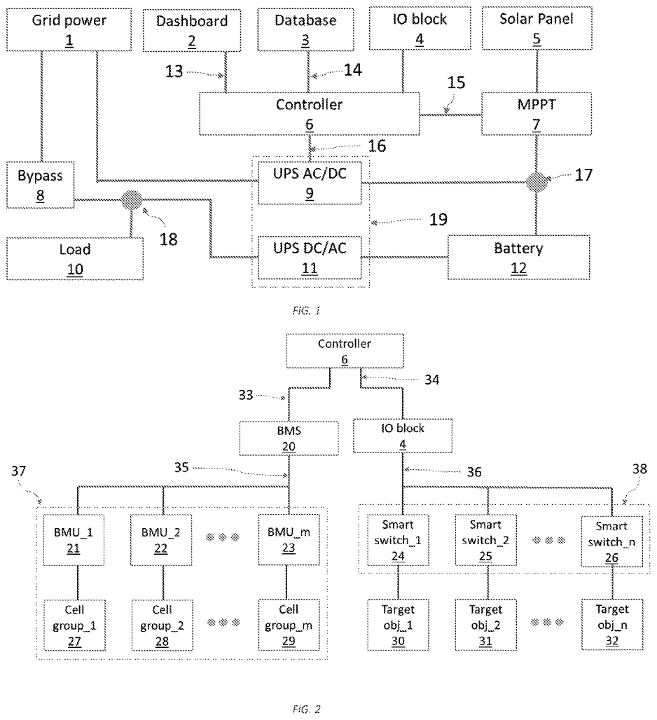

In FIG. 1, the architecture of the Smart UPS system is depicted, with the controller 6 acting as the essential platform for all applications. The primary power source can be selected from either the grid power 1 or the solar panel 5, which can be replaced by other renewable energy sources such as wind turbines. During normal operation with the electricity network available, the load 10 is powered by the grid power 1 and the bypass 9 is closed. A primary power source selector in the form of a smart switch 18 that controls the switch between the grid power 1 and the secondary power source 12 for the load 10. The battery 12 is in charging mode when the primary power source is in use, and its charging power is selected from either the grid power 5 through the UPS AC/DC converter or from the solar panel 5 through the maximum power point tracking battery charge controller 7 (“MPPT”).

The selection of the charging source is controlled through the smart switch 17 based on the system configuration and current operational conditions. During a power outage, the load 10 is powered by the battery 12 through the UPS DC/AC converter 11 and controlled. The communication between the controller 6 and the UPS AC/DC converter 9 uses the CAN bus protocol through the link 16, and the communication between the controller 6 and the MPPT battery charge controller 7 through the link 15 also uses the CAN bus protocol.

The controller 6 sends information to the local dashboard 2 via the link 13 for display. The remote Cloud server's database 3 receives data packets from the controller 6 through IoT using the MQTT protocol. The input output (“IO”) block 4 is linked to the controller 6 through corresponding general IO ports.

FIG. 2 provides a detailed description of how the controller 6 communicates with the battery management system (“BMS”) 20, which is a component of the battery 12, and the IO block 4. The communication protocol over the link 33 is based on the CAN bus. The link 34 transmits logic signals for turning the smart switch array 38 on and off, as well as for controlling the target objects 30, 31, and 32. The BMS 20 communicates with the battery pack 37, which is a part of the battery 12, through the CAN bus. The battery pack 37 comprises a group of battery management unit (“BMU”) 21, 22, and 23 and their respective battery cells 27, 28, and 29. Each BMU controls a cell group using the CAN bus.

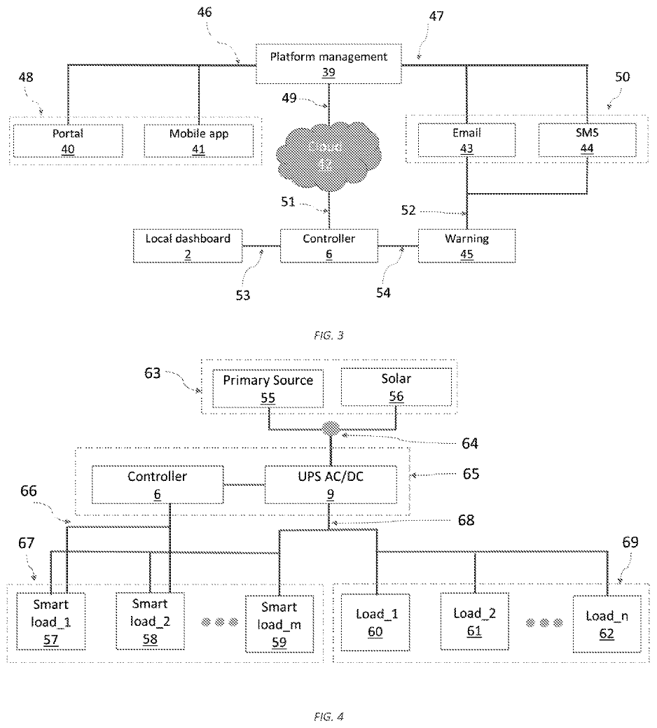

FIG. 3 depicts the communication between the controller 6 and various peripherals. The local dashboard 2 displays data received from the controller 6 via channel 53. IoT data packages are sent via a IoT channel 51 to the Cloud server 42, which bridges them onto the database 3. The database 3 can be securely accessed by the portal 40 and mobile app 41 through the platform management 39. The controller 6 also generates warning messages 45, which are registered and stored in the database 3 and sent as an email 43 and SMS 44. The user interface group 48, consisting of the portal 40 and mobile app 41, connects to the platform management 39 via a link 46. The warning messaging group, consisting of an email 43 and SMS 44, connects to the warning block 45 via a link 52.

In FIG. 4, the loads, and their connection to the controller 6 are depicted. The load 10 comprises two groups: the smart load group 67 with smart loads 57, 58, and 59, and the normal load group 69 with loads 60, 61, and 62. While the smart load group 67 is powered and controlled by the Smart UPS system, the normal load group 69 is only powered by the Smart UPS system but not controlled by the controller 6. The solar block 56 consists of the solar panel 5 and the MPPT battery charge controller 7, and the primary power source 55 can be selected from either the grid power 1 or the solar panel 5.

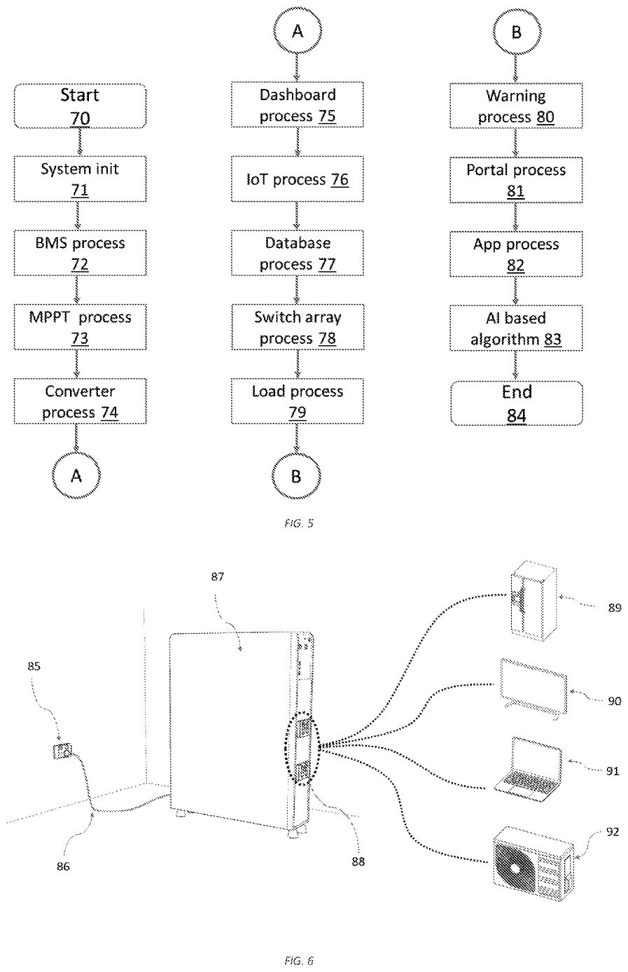

FIG. 5 presents a flow chart detailing the system software running on the controller 6. Upon startup at 70, the system performs initialisation functions. Subsequently, the system executes the configuration and individual tasks in a sequence comprising the following processes: BMS process 72 for battery management, MPPT battery charge controller operation 73 for solar energy source management, converter operation 74 for grid power connection and management, dashboard process 75 for testing and configuration, IoT management 76 for communications via the Internet, database management 77 for data storage and secured access, switch array process 78 for control over the target objects, load management 79 for communication and power on and off, warning message process 80 for constructing and issuing messages, portal communication 81 for user interface and remote operation, mobile app communication 82, and embedded machine learning 83 for specifically designed algorithms.

FIG. 6 depicts the Smart UPS system as a standalone device that can be easily installed by plugging it into a wall socket. The Smart UPS 87 is connected to the primary power source, while the electrical appliances 89, 90, 91, and 92 are connected to the secondary power sockets located on the utility side of the Smart UPS 87. This configuration ensures a stable and uninterruptible power supply to the appliances, enabling them to operate normally even during power outages or fluctuations.

In this patent specification, adjectives such as first and second, left and right, above and below, top and bottom, upper and lower, front and back, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

The above description of various embodiments of the present invention is provided for purposes of description to one of ordinary skill in the related art. It is not intended to be exhaustive or to limit the invention to a single disclosed embodiment. Numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. An uninterruptible power supply system, comprising:
a primary power source selector that is selectable between a plurality of primary power source options;
a battery management system comprising a plurality of battery management units;
a controller for controlling the primary power source and the battery management system; and
a bus subsystem including a CAN bus for connecting together the primary power source selector, the battery management system and the controller;
wherein a primary power source selected by the primary power source selector is determined by the controller based on an analysis of primary power source parameters and peripheral load parameters.

2. The uninterruptible power supply system of claim 1, wherein the controller is connectable to a display panel dashboard for providing a local interface for system testing, debugging and configuration.

3. The uninterruptible power supply system of claim 1, wherein the dashboard provides end users with visualised real-time data.

4. The uninterruptible power supply system of claim 1, wherein the controller includes an array of smart switches designed and wired to perform control tasks over specific target objects.

5. The uninterruptible power supply system of claim 1, wherein the controller enables peripherals and features to be excluded so that the system can be used as a plug-and-play standalone device using a wall socket as the primary power source.

6. The uninterruptible power supply system of claim 1, wherein the plurality of primary power source options are selected from: grid power; engine generator power; solar power; wind power; hydro power; and external battery power.
